(19) United States
(12) Patent Application Publication
(10) Pub. No.: US 2018/0120449 A1
(43) Pub. Date: May 3, 2018

(54) SYSTEM AND METHOD FOR FORECASTING THE GEOMAGNETIC RESPONSE TO SOLAR STORMS

(71) Applicant: Neel Prakash SAVANI-PATEL, Washington, DC (US)

(72) Inventor: Neel Prakash SAVANI-PATEL, Washington, DC (US)

(21) Appl. No.: 15/624,647

(22) Filed: Jun. 15, 2017

Related U.S. Application Data
(60) Provisional application No. 62/350,338, filed on Jun. 15, 2016.
(60) Provisional application No. 62/510,976, filed on May 25, 2017.

(51) Int. Cl. G01T 1/16; G01W 1/10; G01W 1/16

(52) U.S. Cl. CPC G01T 1/16; G01W 1/16; G01W 1/10

(57) ABSTRACT

Systems and methods for predicting the Earth's geomagnetic response to coronal mass ejections (CMEs) are provided that are based on predictions of the magnetic vectors of the CME along Earth's trajectory. The systems and methods preferably utilize estimates of noise in the CME, as well as estimated magnetic characteristics of the shock and sheath regions of the CME.

This application claims priority to U.S. Provisional Application Ser. No. 62/350,338 filed Jun. 15, 2016, and U.S. Provisional Application Ser. No. 62/510,976 filed May 25, 2017. Their entire disclosures are incorporated herein by reference.

### GOVERNMENT RIGHTS

This invention was made with government support under SHINE Grant No. 1433202 awarded by the National Science Foundation (NSF), and under a SECCHI Contract awarded by the National Aeronautics and Space Administration (NASA). The government has certain rights in this invention.

### BACKGROUND OF THE INVENTION

### 1. Field of the Invention

The present invention relates to coronal mass ejections (CMEs), and, more specifically, to predictions of the Earth's geomagnetic response to CMEs based on predictions of the magnetic vectors within CMEs.

### 2. Background of the Related Art

The process by which the Sun affects Earth's environment on short timescales is predominately driven by the amount of magnetic reconnection between the solar wind and Earth's magnetosphere. Reconnection occurs most efficiently when the solar wind magnetic field has a southward component. The most severe impacts are during the arrival of a coronal mass ejection (CME), also referred to as a “solar storm,” when the magnetosphere is both compressed and magnetically connected to the heliospheric environment. Unfortunately, accurately forecasting magnetic vectors within coronal mass ejections remains elusive.

### SUMMARY OF THE INVENTION

An object of the invention is to solve at least the above problems and/or disadvantages and to provide at least the advantages described hereinafter.

Therefore, an object of the present invention is to provide a system and method for predicting Earth's geomagnetic response to a CME.

Another object of the present invention is to provide a system and method for predicting Earth's geomagnetic response to a CME that utilizes noise estimates in the CME.

Another object of the present invention is to provide a system and method for predicting Earth's geomagnetic response to a CME that utilizes the estimated magnetic characteristics of shock and sheath regions.

Another object of the present invention is to provide a system and method for predicting Earth's geomagnetic response to a CME in which an initial magnetic flux rope orientation estimate at the Sun is adjusted using coronagraphic data.

Another object of the present invention is to provide a system and method for predicting Earth's geomagnetic response to a CME that creates a time-varying magnetic profile of the CME.

Another object of the present invention is to provide a system and method for predicting Earth's geomagnetic response to a CME that predicts the magnetic field direction of the CME along Earth's trajectory.

To achieve at least the above objects, in whole or in part, there is provided a method of predicting Earth's geomagnetic response to a coronal mass ejection (CME), comprising determining an initial magnetic profile of the CME at the Sun base on observations of the source of the CME, creating a time-varying magnetic profile of the CME, predicting the magnetic field direction of the CME along Earth's trajectory; and predicting Earth's geomagnetic response to the CME based on the predicted magnetic field direction at Earth.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a flowchart illustrating steps for predicting Earth's geomagnetic response to a CME, in accordance with one preferred embodiment of the present invention;

FIG. 2 is a table showing the parameters of eight CME events between the years 2010 and 2014;

FIG. 3 is a 171 angstrom image from the AIA instrument onboard the SDO spacecraft taken at 20.14 UT on Jan. 7, 2014;

FIG. 4 is a block diagram of a system for predicting Earth's geomagnetic response to a CME, in accordance with one preferred embodiment of the present invention;

FIG. 5 are images from the COR2 instruments onboard the two STEREO spacecraft (A and B) and the LASCO instrument onboard the Solar and Heliospheric Observatory (SOHO) that are used to triangulate the CME structure;

FIG. 6 is a schematic diagram illustrating how a CME noise profile is created;

FIG. 7 is a schematic diagram illustrating how the magnetic characteristics of shock and sheath regions are estimated;

FIG. 8 are graphs of predicted (red) and observed (L1; blue) magnetic vectors in spherical GSE coordinate system for eight CME events between 2010 and 2014;

FIG. 9 are graphs showing Kp index values in response to the passage of eight CMEs between 2010 and 2014 (green) and the Kp^{(BSS)} forecast using the estimated magnetic vectors within the CME displayed in FIG. 8 (red);

FIG. 10 are graphs displaying the fictitious magnetic vector Kp^{(BSS)} predictions had the standard Bothmer-Schwenn scheme been used for the January 2014 event in red, along with the adjusted Bothmer-Schwenn (BSS scheme) prediction in gray, which takes into account the two active regions that were associated with this CME;

FIG. 11 is a graph that displays the effect of moving the Earth trajectory parallel to the flux rope axis towards the southern leg of the CME;

FIG. 12 are graphs that display the resulting magnetic vector prediction and Kp^{(BSS)} forecast for a manual change to the Earth-trajectory;

FIG. 13 is a graph that displays a manual change for the January 2014 event, by decreasing the impact parameter from 0.91 to 0.21;

FIG. 14 are graphs that display the resulting magnetic vector prediction and Kp^{(BSS)} prediction for an Earth trajectory moved perpendicular to the CME axis;

FIG. 15 are graphs that display the resulting magnetic vector prediction and Kp^{(BSS)} prediction for a manual increase in the tilt angle of the CME axis from 40 degrees to 60 degrees;

FIG. 16 are graphs that display the resulting magnetic vector prediction and Kp^{(BSS)} prediction for a manual increase in the maximum field strength along the central axis by 20 (B I=31.8 nT);

FIG. 17 are graphs that display the resulting magnetic vector prediction and Kp^{(BSS)} prediction for an increase in the CME velocity of 470 km/s;

FIG. 18 is a table showing skill metrics for six CME events (c-h);

FIG. 19 is a table that displays the contingency table for each CME when a single event is a 3-hour Kp interval and a “Hit” is defined when both observed and predicted (BSS) have Kp≥5 (i.e., Kp^{(o)}≥Kp^{(BSS)});

FIG. 20 is a contingency table showing skill metrics for eight CME events (a-h); and

FIG. 21 is a table displaying overall metric skills for T0, T27, BSS, NOAA/SWPC and CCMC/SWRC.

### DETAILED DESCRIPTION OF PREFERRED EMBODIMENTS

Throughout the specification, the singular and plural versions of the terms “coronal mass ejection (CME)” and “solar storm” are used interchangeably. In addition, the terms “helicity” and “chirality” are used interchangeably.

CMEs are often observed to have twisted “flux rope” magnetic field structures. If favorably oriented, these can lead to extended southward excursions of the interplanetary magnetic field (IMF) as the CME passes by, resulting in periods of enhanced reconnection on Earth's dayside and energy input into the magnetosphere. Draping of the IMF around the CME as it moves through the solar wind may also give rise to southward fields. In contrast, northward-directed fields inhibit reconnection, resulting in a weaker magnetospheric response. While prolonged southward fields are often observed without the presence of a clear structured transient, the additional plasma parameters often associated with CMEs usually make them the most geo-effective events. One aspect of the present invention is the inference of the direction of the flux rope fields inside a CME before it arrives at Earth, which is a major advance in geomagnetic activity prediction.

In addition, the CME's initial configuration and its interaction with the inhomogeneous ambient solar wind can lead to deformations, rotations, and deflections of the magnetic field, which are difficult to quantify. Distortions of CMEs have previously been observed by coronagraphs. However, their influence on the magnetic structure is difficult to estimate because the magnetically-dominated regions of CMEs appear as dark cavities within images, such as those seen by the STEREO spacecraft. Therefore, a common approach to predicting magnetic vectors within a CME propagating towards Earth is to use solar observations as inputs into 3D computational simulations. Unfortunately, obtaining realistic magnetic field directions at Earth from such calculations is scientifically challenging and computationally intensive.

Thus, models used for routine CME forecasts by various space weather services do not include magnetic structures within the simulated CMEs. For example, ENLIL models the propagation of CMEs from ˜20 solar radii (Rₛ) to beyond Earth at 215 Rₛ and includes the background solar wind magnetic field. However, the CME is simplified to a high pressure plasma pulse with a size and propagation direction estimated from solar imagery. CME arrival-time predictions from these models provide lead times of ˜2-3 days, and their accuracy has been well investigated. In contrast, the important magnetic vector information is only revealed when in situ measurements are made by spacecraft upstream of Earth at the first Lagrangian position (L1)˜1 hour prior to the CME arriving at Earth, thereby severely limiting the lead time available for reliable, magnetic field-based, storm warnings.

Difficulties in observationally determining the magnetic profile of a CME arriving at Earth from only solar imagery predominately lie with several complex stages that change the initial solar configuration to the final topological structure at Earth. The present invention allows one to make statistically significant predictions by simplifying the complex behavior to a core set of parameters.

Theory and observations suggest that the magnetic fields inside CMEs are often twisted “flux ropes.” Such twisted fields are also often found in in-situ during the passage of CMEs. However, the challenge has been to predict the structure of in-situ flux ropes from observations of the source of the CME at the Sun.

A link between solar active regions or eruptive filaments and flux rope structures has been previously proposed. Further supporting evidence is provided by the chirality of these structures and their axis orientation in the ecliptic plane and over a large range of heliographic latitudes. Evidence has shown that the relationship of interplanetary flux ropes and their solar progenitors is more straightforward for filaments than active regions. However, a large fraction of CMEs are associated with active regions.

It has been suggested that the magnetic topology of CMEs should be driven by conditions below the solar surface. In particular, a scheme has previously been proposed that predicted the magnetic topology based on two parameters: (1) whether the solar cycle number is even or odd; and (2) whether the CME originated in the northern or southern hemisphere. However, it is now clear that this scheme can fail in some cases. For example, an event was reported whose overlying field arcade from which a CME erupted spanned two solar active regions. The resulting interplanetary magnetic flux rope structure was shown to be different from that of a prior CME that erupted from just one of these active regions. Thus, the present invention utilizes an additional parameter to the hemisphere-handedness scheme to allow for a single or double active region source, as will be explained in more detail below.

The Earth trajectory through a model CME strongly influences the predicted magnetic field vectors at Earth. The vectors are also affected by evolution of the CME as it propagates to Earth. Radial propagation of CMEs have suggested a flattening of a circular cross section CME. However, in-situ evidence, often from model fittings, suggest a circular cross-section may be appropriate on local scales. The non-radial extent is less well constrained. CME deflections and rotations may also influence the magnetic structures that encounter the Earth, as can deformations of a CME due to interactions with the ambient solar wind or other interplanetary CMEs. Studies have also shown evidence that the magnetic flux rope structure within a CME may also erode away during propagation.

### I. System and Method for Predicting Earth's Geomagnetic Response to a CME

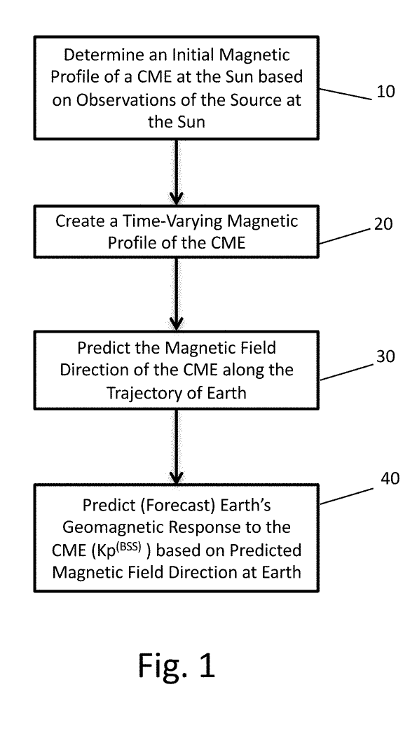

FIG. 1 is a flowchart illustrating steps for predicting Earth's geomagnetic response to a CME, in accordance with one preferred embodiment of the present invention. At step 10, one determines an initial 3D magnetic profile of a CME at the Sun based on observations of the source of the CME at the Sun, as will be explained in more detail below. At step 20, a time-varying magnetic profile of the CME is created, as will be explained in more detail below. At step 30, the magnetic field direction of the CME along the trajectory of Earth is predicted based on the time-varying magnetic profile of the CME, as will be explained in more detail below. At step 40, Earth's geomagnetic response to the CME is predicted based on the predicted magnetic field direction at Earth, as will be explained in more detail below.

Based on analysis of eight Earth-directed CMEs between 2010 and 2014, it has been determined that the incorporation of magnetic field vectors in this way can significantly improve geomagnetic forecasts by providing a time-varying magnetic profile of the CME. The time-varying magnetic profile is then incorporated with a technique that creates a time-varying Kp index forecast that replicates the forecast deliverables by the National Oceanic and Atmospheric Administration (NOAA).

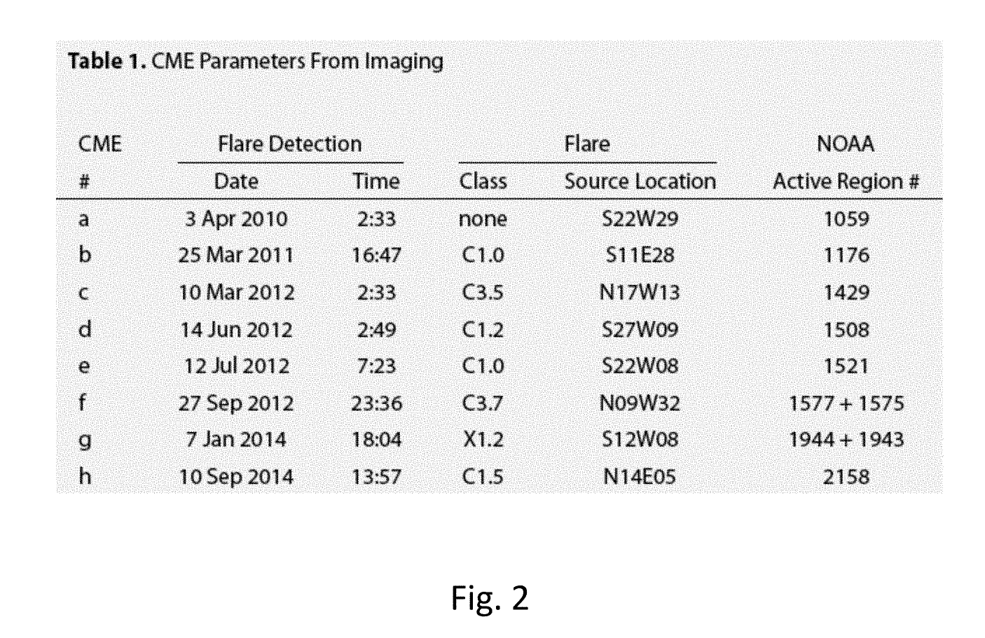

A total of eight Earth-directed CME events between 2010 and 2014 were selected with three driving criteria: (1) unambiguously define the solar source of the overlying field arcade from a single or double active region and possibly with an eruptive flare; (2) a clear leading edge structure from multiple remote observations to unambiguously define the size and orientation of the CME morphology; and (3) a significant measurable effect by geomagnetic indices. Details of the eight chosen events are displayed in the table shown in FIG. 2.

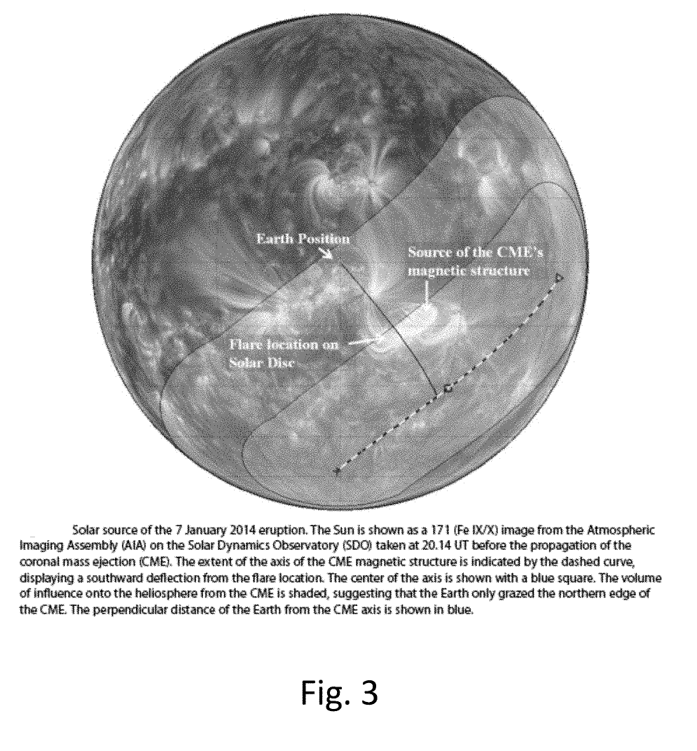

FIG. 3 is a 171 angstrom image from the AIA instrument onboard the SDO spacecraft taken at 20.14 UT on Jan. 7, 2014. This event has an inconclusive Earth-arrival time and in situ profile, and highlights the complexity in forecasting processes. The uncertainty from this event stems from the predicted arrival time being approximately 24 hours earlier than when on-duty forecasters labeled the actual arrival from real-time L1 in-situ data. Throughout this period, the solar wind plasma parameters displayed significantly lower velocities than were expected, as well as missing a strong and distinctive magnetic field rotation of an obstacle.

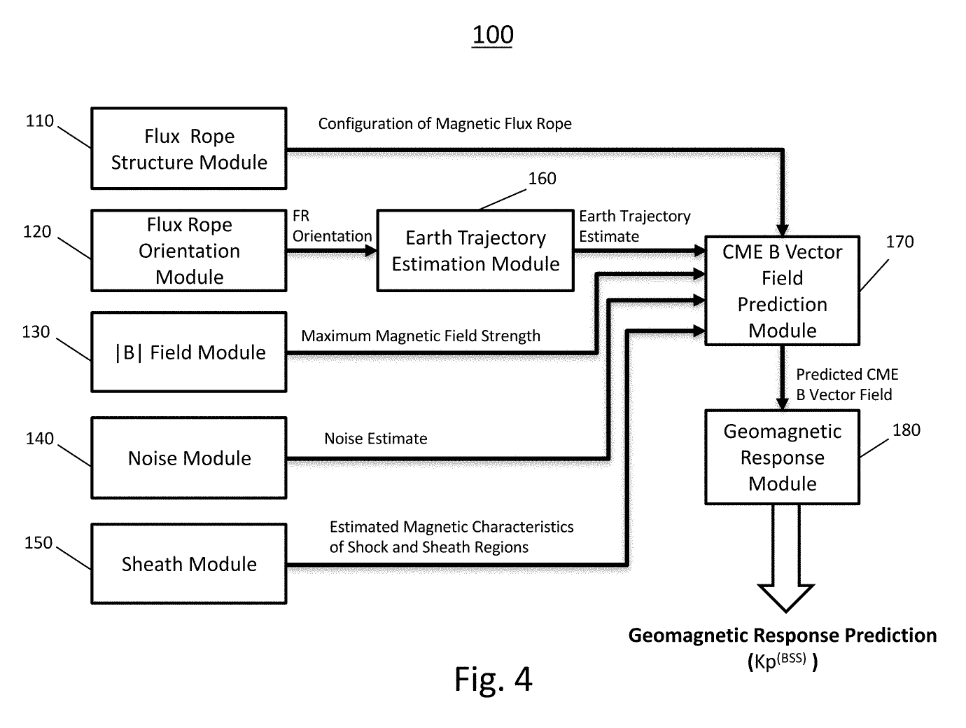

FIG. 4 is a block diagram of a system 100 for predicting Earth's geomagnetic response to a CME, in accordance with one preferred embodiment of the present invention. The system includes a flux rope structure module 110, a flux rope orientation module 120, a |B| field module 130, a noise module 140, a sheath module 150, an Earth trajectory module 160, a CME predicted B vector field module 170 and a geomagnetic response module 180.

The specialized system 100 for predicting Earth's geomagnetic response to a CME is preferably implemented with one or more programs or applications run by one or multiple processors. The programs or applications are respective sets of computer readable instructions stored in a tangible medium that are executed by one or multiple processors.

The processor(s) can be implemented with any type of processing device, such as a special purpose computer, a distributed computing platform located in a “cloud”, a server, a tablet computer, a smartphone, a programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of running the programs and/or applications used to implement the specialized system 100 for predicting Earth's geomagnetic response to a CME can be used as the processor(s).

Further, it should be appreciated that the various modules that make up the system 100 could be implemented with a separate processor for each module, any combination of multiple processors or one processor. For example, all the modules could be implemented with programs and/or applications running on a common processor.

The operation of the system 100 will now be described, with reference to the various modules that make up the system 100. At a high level: (1) the flux rope structure module 110 determines the configuration of the magnetic flux rope inside the CME; (2) the flux rope orientation module 120 determines the orientation of the flux rope at the Sun; (3) the |B| field module 130 estimates the maximum magnitude field strength in the CME; (4) the noise module 140 generates an estimate of the noise within the CME; (5) the sheath module 150 predictively estimates the magnetic characteristics of the shock front of the CME and the sheath region (which will be defined below); (6) the Earth Trajectory Estimation Module utilizes the flux rope orientation information from the flux rope orientation module 120, and generates an Earth trajectory estimate; (7) the CME B vector field prediction module 170 utilizes the magnetic flux rope configuration information, the earth trajectory estimate, the estimated maximum magnetic field strength in the CME, the noise estimate and the estimated magnetic characteristics of the shock and sheath regions, and generates a predicted CME magnetic (B) vector field using a computational scheme/model that will hereinafter be referred to interchangeably as the “BSS model” or the “BSS scheme”; and (8) the geomagnetic response module utilizes the predicted CME B vector field and generates a geomagnetic response prediction (forecast) (Kp^{(BSS)}).

### A. Kp Theory and Forecasting (CME B Vector Field Prediction Module 170 and Geomagnetic Response Module 180)

The NOAA Space Weather Prediction Center (SWPC) is the official U.S. source for space weather forecasts. For geomagnetic storms, their current procedure is to: (1) release a geomagnetic “watch” notice after a solar eruption is observed, i.e., 36-72 hours prior to expected storm arrival; (2) send out a “warning” ˜1 hour prior to storm onset using data from ACE/Wind spacecraft at the L1 point to formulate a robust Kp prediction based on established relations between the solar wind parameters and Kp; and (3) provide “Alerts” in a now-casting/real time format during the geomagnetic storm using a real-time proxy of the official Kp index. SWPC also publishes routine 3-day Kp forecasts based on a heuristic approach that is heavily dependent on the skill and personal experience of the on-duty forecaster (for example, in interpreting ENLIL simulation results and incorporating knowledge of historical events)

NASA's Space Weather Research Center (SWRC) hosted by the CCMC (Community Coordinated Modeling Center) at the Goddard Space Flight Center (GSFC) employs more experimental forecasting procedures using the latest scientific techniques that have only recently been deployed in an operational-like setting. The CCMC is an inter-agency partnership to facilitate community research and accelerate implementation of progress in research into space-weather operations. CCMC/SWRC are tasked with addressing the space weather needs of NASA's robotic missions through experimental research forecasts, notification and analysis. As part of its activities, CCMC gathers predictions from researchers around the world and compares them with the actual observed space weather in order to understand the strengths and limitations of the different forecasting techniques.

Both NOAA/SWPC and CCMC/SWRC use ENLIL to model the propagation of CMEs between the Sun and Earth, and estimate arrival times. However, the currently released ENLIL models do not include CME magnetic fields. Rather, only the magnetic structure of the ambient solar wind is included in the model. Thus, ENLIL cannot currently provide any forecasts of the magnetic field vectors inside CMEs. CCMC are implementing an experimental method to forecast Kp with quantitative uncertainties using the maximum field strength from ENLIL model runs.

Kp is the global magnetospheric index often used by forecasters to indicate the severity of a space weather event. A function is required that characterizes the coupling of the solar wind to the magnetosphere. Many functions that couple the solar wind to a wide variety of magnetospheric activity have been proposed in the past, often incorporating the magnetic field orientation. A recent study suggests that one parameter correlates best with 9 out of 10 indices of terrestrial activity. This parameter, dΦ/dt, represents the rate at which magnetic flux is opened at the magnetopause and is defined as

dΦ/dt=v^{4/3}|B|^{2/3} sin^{8/3}(θ_{c}/2) (1)

where v is the velocity of the solar wind; |B| is the magnetic field magnitude; and the interplanetary magnetic field (IMF) clock angle is defined by θc≡tan⁻¹(By/ [symbol] ). The correlation coefficient of dΦ/dt with the Kp index is r=0.76. The predicted magnetic field time series in GSM coordinate system is used to calculate a theoretical magnetic flux rate. A Kp prediction is then generated by the empirical correlation

Kp^{(BSS)}=9.5−e^{A-B(dΦ/dt)} (2)

where A=2.18, B=5.20*10⁵, and with the velocity and magnetic field measured in km/s and nT, respectively. The Kp predictions are easily converted to the official NOAA geomagnetic storm scale (G1 to G5) by a linear mapping of the Kp values.

Equation (1) displays how the predicted values of Kp are influenced by the solar wind speed. The average velocity during passage of the CME was used, as measured from the ACE and WIND data sets at L1. The reason for implementing the observed velocity from L1 is a simple one; we wish to understand and isolate the effects of the predicted magnetic vectors without prejudice from uncertainties in other model parameters that influence estimated arrival time or velocity.

The derived Kp estimates using real time in-situ data from L1 are currently implemented within the CCMC integrated Space Weather Analysis System (iSWA). The real L1 data has been used to derive the Kp for several CMEs and compared to a proxy L1 time-series created from an ensemble of ENLIL runs. The level of geomagnetic activity predicted using the L1 data was shown to have a root mean square error of less than a single geomagnetic storm scale.

Currently CCMC/SWRC use a simple and arbitrary process for the long-lead time geomagnetic activity forecasts. The magnetic field strength from ENLIL in the compressed sheath material ahead of a CME is assumed to be constantly pointing West, Southwest or South during the passage of the CME, and the expected Kp is estimated for each case. The average Kp estimate is taken from the Southwest direction. The Kp forecast for NASA robotic operations issued by CCMC/SWRC is then the range between these extreme cases, with the highest Kp prediction originating from a southward field.

The observed arrival time of the CME from L1 data is used only as a guide to define the time-interval for the Kp^{(BSS)} prediction. This is because the quantitative skill score metrics are defined based upon a time interval where the predicted and observed Kp have a maximum correlation. This time shifting process enables a consistent analysis of Kp skill for all CMEs. However, implementation of this tool in an operational setting will require the arrival time to be fixed and dictated by a separate arrival time forecast process (which is likely to be determined through multiple ENLIL model runs).

### B. Flux Rope Model (Flux Rope Structure Module 110)

The configuration of the magnetic flux rope by the flux rope structure module 110 is calculated by assuming a constant-alpha force-free (CAFF) flux rope and a cylindrical geometry locally around the Earth's predicted trajectory through the CME. Previously, triangulation of the CME direction from remote sensing have provided adequate information as to the expected structure arriving at L1. However a Grad-Shafranov reconstruction technique would not be appropriate in creating a model to estimate the structure.

The magnetic vectors generated along the Earth's trajectory from a CAFF flux rope model is created from the MHD momentum equation under magnetostatic equilibrium, which can be reduced to J=αB. A solution to this equation can be used to generate a cylindrical magnetic flux rope with circular cross section, with the components of the magnetic field vector expressed by Bessel functions, and α commonly set to 2.41.

### C. Solar Initiation (Flux Rope Structure Module 110)

The helicity and initial orientation of the magnetic flux rope structure within a CME are inferred by the flux rope structure module 110 from using the “Bothmer-Schwenn” scheme (Bothmer, V., and R. Schwenn (1998), The structure and origin of magnetic clouds in the solar wind, Ann. Geophys., 16, 1-24, doi:10.1007/s00585-997-0001-x). This relates the flux rope properties to sunspots, the solar cycle, and whether the CME originates on the northern or southern solar hemisphere. The reliability of this solar hemispheric rule remains controversial. It was only in late 2013 when the probability of a CME's topology conforming to the hemispheric rule was re-confirmed to be greater than or equal to 80%. Thus, the initial helicity and field structure of CMEs can be inferred from this scheme with a reliability that is likely to be ˜80%.

Ordinarily, a CME is linked to a single active region where the standard Bothmer-Schwenn scheme should be applied. However, in cases such as the January 2014 event, the magnetic loop structure before eruption has a leading negative polarity spanning over two active regions. Thus, a South-West-North, flux rope field direction from southern hemisphere of solar cycle 23 under the Bothmer-Schwenn scheme is appropriate. This implies the CME has a right handed chirality.

### D. Remotely Sensed Evolution (Flux Rope Orientation Module 120)

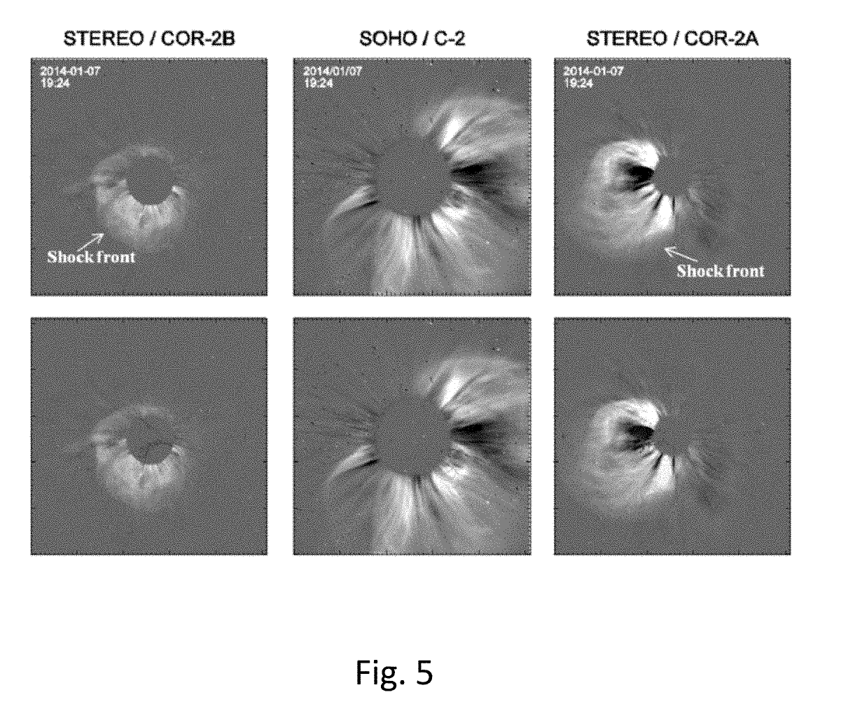

Since deflections, rotations and other interactions may occur during CME propagation to Earth, the initial Bothmer-Schwenn configuration is adjusted by the flux rope orientation module 120 using coronagraphic data from the Solar and Heliospheric Observatory (SOHO) and STEREO solar observation missions. The final tilt and source region of the magnetic flux rope, after which radial propagation is assumed, is estimated using the graduated cylindrical shell (GCS) model, when the CME reached ˜15Rₛ. FIG. 5 displays images from the COR2 instruments onboard the two STEREO spacecraft (A and B) and the LASCO instrument onboard SOHO that are used to triangulate the CME structure. Where three well-separated observations exist, the GCS model provides relatively well-constrained estimates of the orientation and size of the CME without any ambiguity. The GCS model may still be implemented without multi-point observations in the same way as various other cone-structure methods can be implemented. However in such cases, the possible degeneracy in the observational morphology limits all methods and thus highlights the difficulties in performing reliable forecasts.

The outputs from the GCS model, along with estimates of the average CME size, are used to create a “volume of influence” defined as the volume the CME is expected to traverse as it propagates through the heliosphere. The shaded region in FIG. 3 displays the projection of this “volume of influence” onto the Sun, suggesting that the Earth grazed the northern edge of this case study event. The projected area is calculated from the “shadow” of the CME that is assumed to be cylindrical in shape with circular cross-section. Two parameters (flux rope axis length and flux rope width) are required to estimate the projected area. The axis length, shown as a dashed curve in FIG. 1, is estimated from the half angle, α_{haw}, given by half the angular width of the CME in a direction parallel to the GCS model axis. The projected width of the CME transverse to this axis is assumed equal to the average CME width, as found from statistical studies.

Any uncertainty in the inferred CME orientation is likely to have only a minimal effect on the predicted magnetic field vectors since it is likely to be eclipsed by the larger uncertainties arising from estimating the magnetic field strength and the assumption of a symmetric cylindrical flux rope, as explained below. The coronagraphic images show how the coronal magnetic loops seen in SDO have been deflected to the south west (FIG. 3). Here, we use coronagraphic imagery to estimate the final CME radial trajectory but one could attempt to increase prediction lead times by, for example, incorporating CME deflections by coronal holes.

### E. Magnetic Field Strength (|B| Field Module 130)

The magnitude of the magnetic field along the central flux rope axis is assumed in the case study to be 18.0 nT. This is calculated by the |B| field module 130 assuming the maximum estimated magnetic field strength within the plasma pile-up region simulated by the WSA-ENLIL+Cone model (10.3 nT) corresponds to the magnetic field strength at closest approach within the flux rope structure. The impact parameter obtained using the volume of influence (set at 0.91 for the January 2014 event) is then used to estimate the maximum field strength along the central flux rope axis. In effect, this technique estimates the |B| of a CME from a correlation of the inner heliospheric CME velocity and a simulated background solar wind field strength driven by magnetograms.

The field strength is inferred from a model currently used for forecasting by CCMC, so this method could be implemented using existing forecasting capabilities. Other methods, whose uncertainties have not yet been statistically quantified, may be used. For example: (1) estimating the poloidal and total flux content of a CME from flare ribbon brightening (Longcope, D., C. Beveridge, J. Qiu, B. Ravindra, G. Barnes, and S. Dasso (2007), Modeling and measuring the flux reconnected and ejected by the two-ribbon flare/CME event on 7 Nov. 2004, Sol. Phys., 244, 45-73, doi:10.1007/s11207-007-0330-7); (2) flux rope speed and poloidal flux injection to estimate field strength (Kunkel, V., and J. Chen (2010), Evolution of a coronal mass ejection and its magnetic field in interplanetary space, Astrophys. J., 715, L80-L83, doi:10.1088/2041-8205/715/2/L80); (3) using radio emissions from the CME core (Tun, S. D., and A. Vourlidas (2013), Derivation of the magnetic field in a coronal mass ejection core via multi-frequency radio imaging, Astrophys. J., 766, 130, doi:10.1088/0004-637X/766/2/130); and (4) using the shock stand-off distance from remote observations which has recently shown the possibility of estimating the field strength upstream of a CME (Savani, N. P., M. J. Owens, A. P. Rouillard, R. J. Forsyth, K. Kusano, D. Shiota, R. Kataoka, L. Jian, and V. Bothmer (2011), Evolution of coronal mass ejection morphology with increasing heliocentric distance. II. In situ observations, Astrophys. J., 732, 117, doi:10.1088/0004-637X/732/2/117) (Poomvises, W., N. Gopalswamy, S. Yashiro, R.-Y. Kwon, and O. Olmedo (2012), Determination of the heliospheric radial magnetic field from the Standoff distance of a CME-driven shock observed by the STEREO spacecraft, Astrophys. J., 758, 118, doi:10.1088/0004-637X/758/2/118) (Savani, N. P., D. Shiota, K. Kusano, A. Vourlidas, and N. Lugaz (2012), A study of the heliocentric dependence of shock standoff distance and geometry using 2.5D magnetohydrodynamic simulations of coronal mass ejection driven shocks, Astrophys. J., 759, 103, doi:10.1088/0004-637X/759/2/103).

Considering the final focus of estimating the magnetic vectors is to predict the terrestrial effects with quantifiable uncertainty, the uncertainty in the predicted Kp index was estimated by varying the field strength over the range |B|=18.0⁺²^{^{σ}}, where σ=6.9 nT. The uncertainty in field strength represents the statistical average from 82 flux rope fittings estimated between 1995-2003. The magnetic vectors were recalculated for each field strength and used to drive estimates of Kp.

### F. Noise Estimate (Noise Module 140)

Initially, realistic estimates of the noise within a solar storm (CME) are made using historical data. This is a static technique using seed values. However, because the current solar cycle (a period of solar activity that varies over a ˜11 year season) is different than prior solar cycles, the noise level is modified as new real-time CMEs are studied. This is an active technique, preferably using machine learning algorithms.

The active technique is a repetition of the static technique, but operates only on the current solar storm. The static technique investigated data from June 2002 to June 2015, split into 4 periods:
Phase 1: 1 Jun. 2002-31 May 2005 (3 years—declining solar cycle)
Phase 2: 1 Jun. 2005-31 May 2009 (4 years—minimum solar cycle)
Phase 3: 1 Jun. 2009-31 May 2012 (3 years—rising solar cycle)
Phase 4: 1 Jun. 2012-31 May 2015 (3 years—maximum solar cycle)

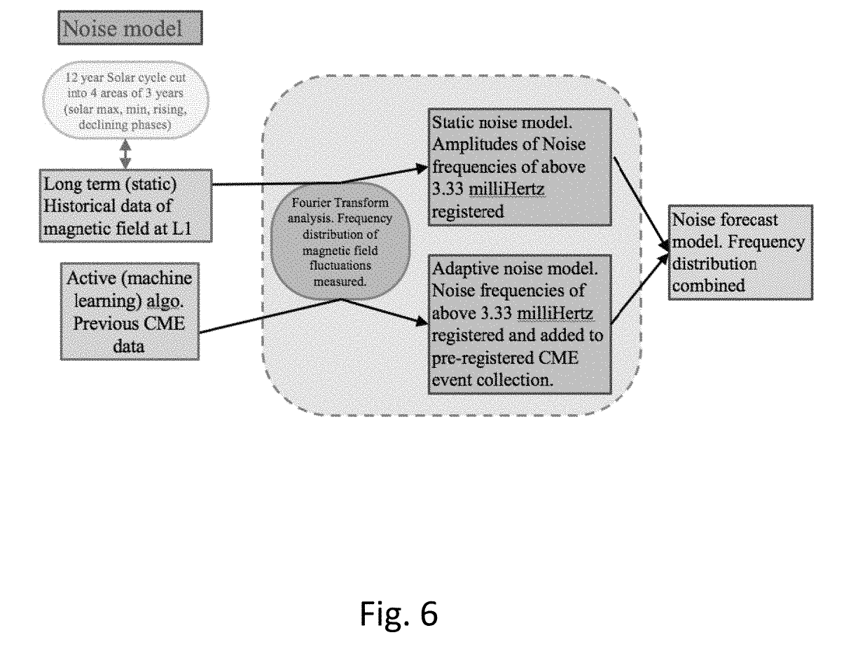

For each phase, a static noise profile was created. However, for the current forecasting, Phase 4 has been used. The analysis is schematically illustrated in FIG. 6, and can be summarized as follows:
Magnetic field at the 30-sec resolution are taken for a 12 hour segment at a random point in time within the phase period. This is preferably done for 40 periods to keep the computational requirements reasonable.
Fourier transform is performed on each 6-hour data, a best fit power law is calculated, and the exponent of the power law is recorded.
All low frequencies (below 3.33 milli-Hertz) are discarded.
The average exponent is estimated for all 40 periods and used to create an estimated noise spectrum, and check is performed to see if exponent of the power spectrum is close to 5/3.
An average of all high frequency time series is created.

The above steps comprise a static noise model, which is essentially a high pass filter that is set to find “wiggles” detected at a rate that is more frequent than 5 minutes. For the adaptive noise model, the above analysis is repeated for the current cycle. Then, the latest CME noise profile is added to the current noise profile and a new average for all the implemented profiles is calculated.

### G. Sheath Region (Sheath Module 150)

The sheath is a region of space that is sandwiched between the organised magnetic obstacle of the solar storm (CME), and the shock front that the storm is driving because it is moving supersonically. The sheath module 150 predictively estimates the magnetic characteristics of the shock and the sheath region. The CME B vector field prediction module uses this estimate to create a larger predictive time window.

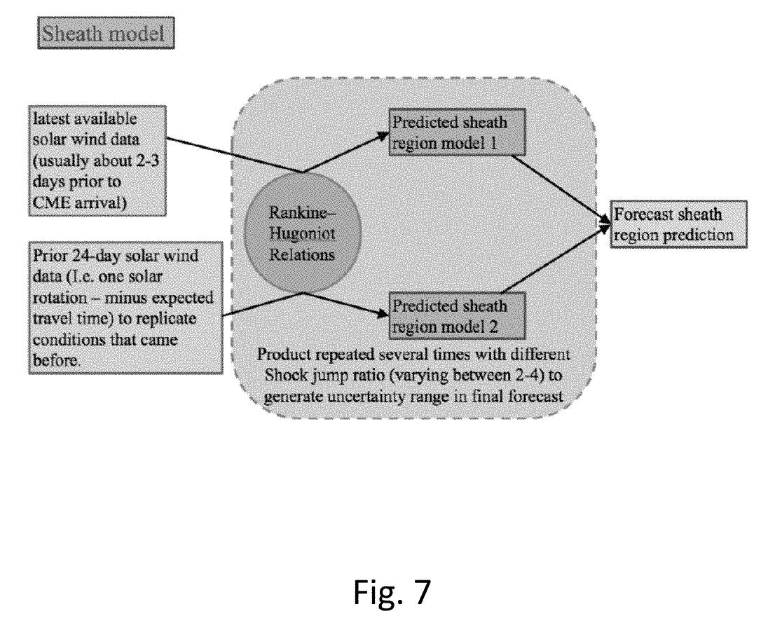

The analysis is schematically illustrated in FIG. 7. It starts with input solar wind data. This data is assumed to be the solar wind conditions just ahead of the solar storm (i.e., the solar wind conditions which the future storm will be travelling through). Assumptions are made with regards to sheath duration and shock strength. As an example, it is assumed that the sheath duration (“Duration”) is 6 hours, and the shock strength “ShockN”=3. The ingested solar wind data is defined as a period of Duration*ShockN hours. The Rankin-Hugoniot (R-H) relations enables the creation of magnetic field strength and vectors of an expected sheath.

This methodology is driven by two different input solar wind conditions: (1) the latest available real-time data at the time the forecast model is operated; and (2) data that is centred on an epoch that is ˜24 days earlier in time. The exact epoch is defined by 27 days minus storm launch time (i.e., the time the storm launches above the Sun or is first seen). These two inputs create their own predication models, which are then averaged to create the final sheath forecast model. A range of uncertainty in the forecast Sheath model is preferably created by varying the ShockN between 2 to 4.

### II. Results Using Detected Events

The January 2014 Earth-directed CME described above and shown in FIG. 2 was used as a case study to highlight how various adjustments effect the predicted magnetic vectors, and hence the resulting Kp predictions. Adjustments to the hypothetical trajectory through the model flux rope structure are manually made to investigate the changes. Details of the implemented constant alpha flux rope model are given in Savani, N. P., A. Vourlidas, A. Pulkkinen, T. Nieves-Chinchilla, B. Lavraud, and M. J. Owens (2013), Tracking the momentum flux of a CME and quantifying its influence on geomagnetically induced currents at Earth, Space Weather, 11, 245-261, doi:10.1002/swe.20038, which closely follows the model of Lepping, R. P., L. F. Burlaga, and J. A. Jones (1990), Magnetic field structure of interplanetary magnetic clouds at 1 AU, J. Geophys. Res., 95, 11,957-11,965, doi:10.1029/JA095iA08p11957. As this model has a circular cross-section cylindrical morphology, all possible trajectories can be generated through adjustments in two perpendicular directions: parallel and perpendicular to the flux rope axis.

As described below, all the different degrees of freedom within the BSS model were manually adjusted in order to study the uncertainties in the time-varying Kp predictions.

### A. Chirality of CME Axis

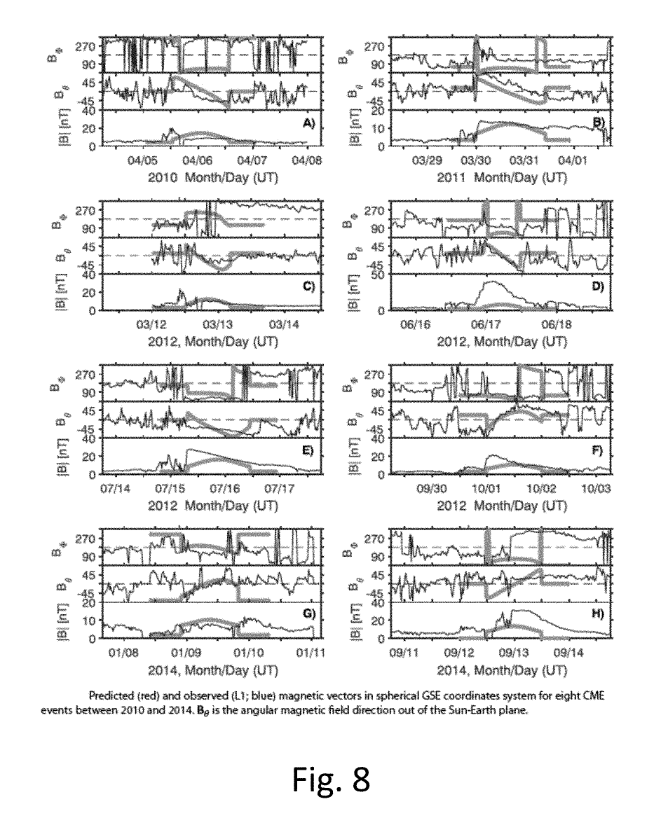

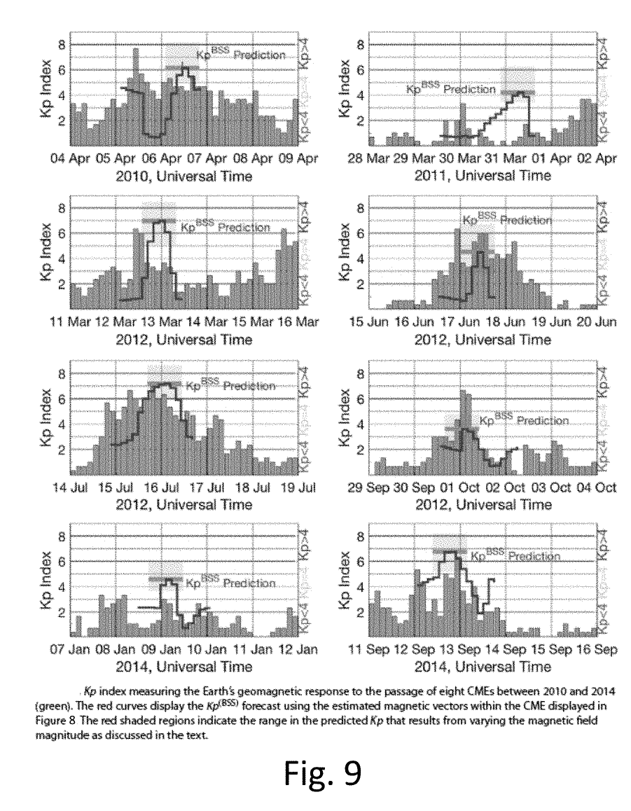

Bothmer and Schwenn suggested that the magnetic topology of CMEs above the solar surface should be driven by the subsurface behavior of the Sun. The original scheme employed a prediction of the magnetic topology based on two parameters (odd/even solar cycle and north/south hemisphere). The methodology described above (BSS scheme) improves the reliability by introducing a third parameter: single/double active region. The introduction of an extra parameter does not change the chirality of the structure, but flips the field direction of the central axis. Cases where the overlying field arcade, from which a CME is released, emanate between two active regions are significantly less frequent than a single active region scenario. CME events G and H in both FIGS. 8 and 9 show observations related to two events originating in double active regions.

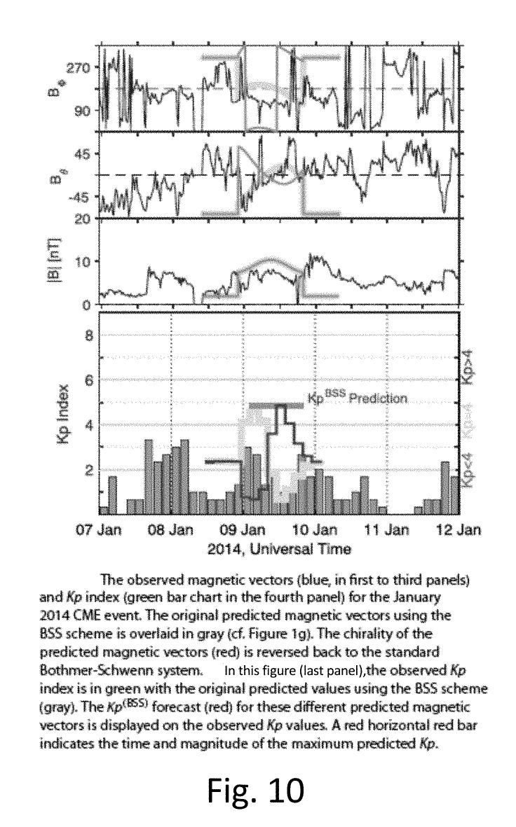

FIG. 10 displays the fictitious magnetic vector Kp^{(BSS)} predictions had the standard Bothmer-Schwenn scheme been used for the January 2014 event (i.e., only a single active region) in red, along with the adjusted Bothmer-Schwenn (BSS scheme) prediction in gray, which takes into account the two active regions that were associated with this CME. Whether the standard or adjusted scheme is used has a significant effect on the predictions made. In particular, the north-south component of the field is flipped such that, with the adjusted scheme, the field rotates from southward to northward with time, whereas with the standard scheme, the rotation is in the opposite direction, as suggested in FIG. 10.

This delay in the southward field excursion, evident in the second panel from the top of FIG. 10, causes the predicted maximum Kp^{(BSS)} to be delayed by approximately 6 hours but the maximum Kp^{(BSS)} remains the same (5−). Uncertainty in the arrival time of this maximum magnitude is of the same order as the uncertainty in the CME Earth arrival time predictions even though the scientific mechanisms are unrelated. Thus, the correct inference of the flux rope topology that emanates from double active regions is crucial for improving peak geomagnetic forecasts.

### B. Variations of Earth Trajectory Parallel to CME Axis

The hypothetical trajectory through the model flux rope structure (determined by the Earth Trajectory Estimation Module 160) is manually adjusted to better understand the effect on the predicted magnetic vectors and Kp^{(BSS)} prediction. This new trajectory through the CME is then the assumed path of Earth. The morphology of this simplified model is a circular-cross section cylinder with a straight central axis, which is a reasonable local approximation for a flux rope at 1 AU. The vector direction of the central axis is determined observationally and through an empirical relationship, as discussed above.

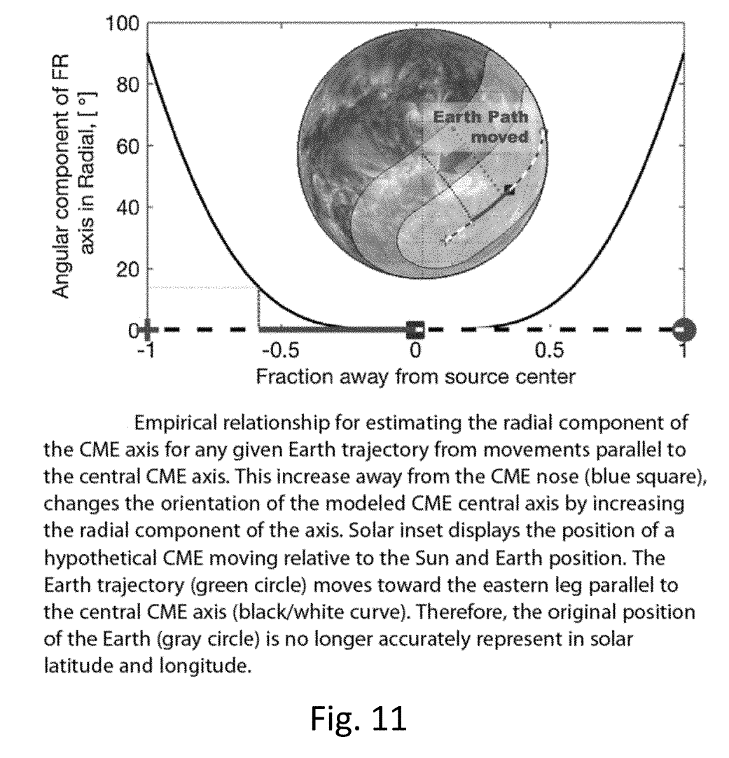

All hypothetical trajectories can be generated by simple modifications along an orthogonal vector set (e.g., East/West and North/South). We chose to define the orthogonal vector set to be parallel and perpendicular to the central flux rope axis. Trajectory movements along the parallel direction increase the radial component of the predicted magnetic flux rope axis as the trajectory moves from the center to either legs of the CME. FIG. 11 displays the effect of moving the Earth trajectory parallel to the flux rope axis towards the southern leg of the CME. A manual adjustment of approximately 50% of the axis half-length was added to the original prediction for the January 2014 event.

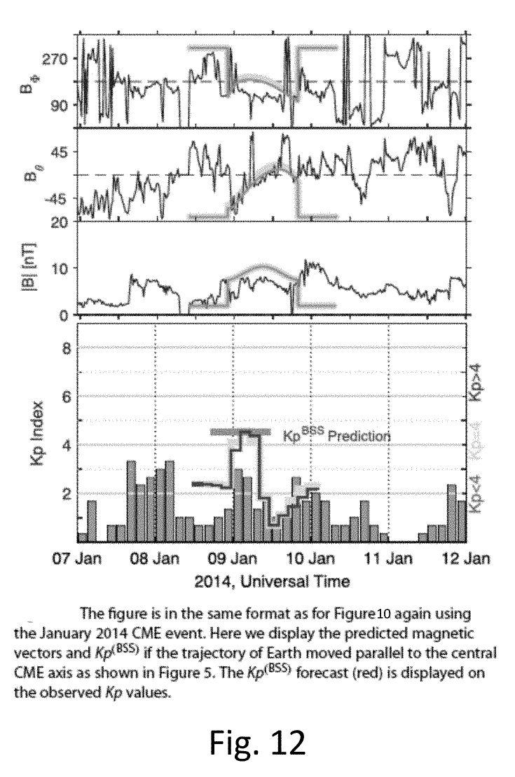

FIG. 12 displays the resulting magnetic vector prediction and Kp^{(BSS)} forecast for a manual change to the Earth-trajectory. In this scenario, the predicted magnetic vector direction has a stronger and slightly more prolonged excursion in the southerly direction. However, the predicted peak in Kp^{(BSS)} remains unchanged at 5−. For some other CMEs, the duration of the southerly field excursion is increased, extending the interval of enhanced Kp values.

### C. Variations of Earth Trajectory Perpendicular to CME Axis

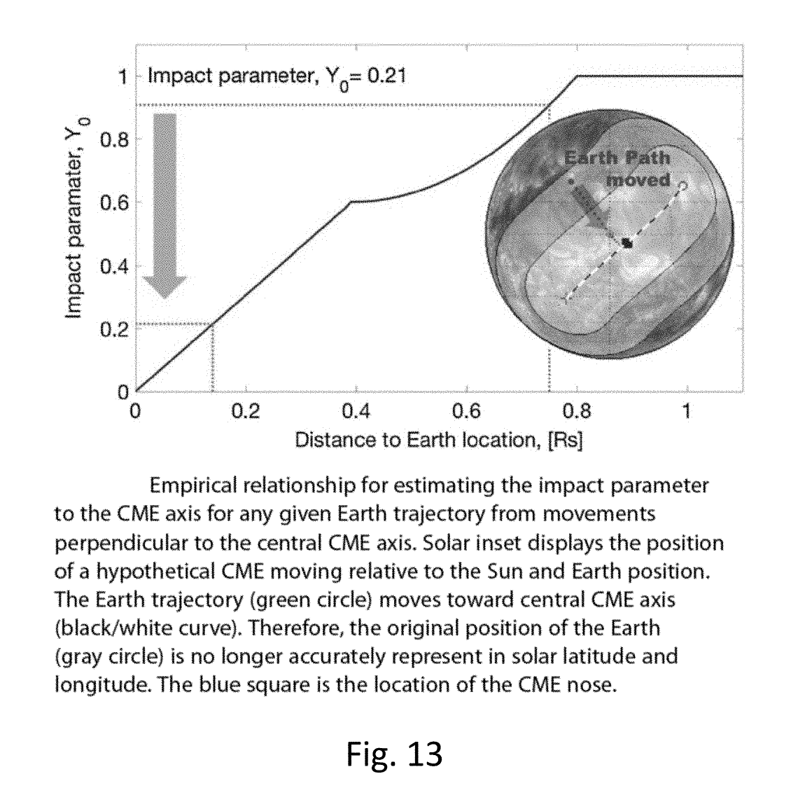

The perpendicular distance of a trajectory from the flux rope axis may be expressed as the impact parameter Y₀ defined as 0 if the trajectory intercepts the central axis of the flux rope, and defined as 1 if it grazes the outer edge. FIG. 13 schematically displays a manual change for the January 2014 event, by decreasing the impact parameter from 0.91 to 0.21.

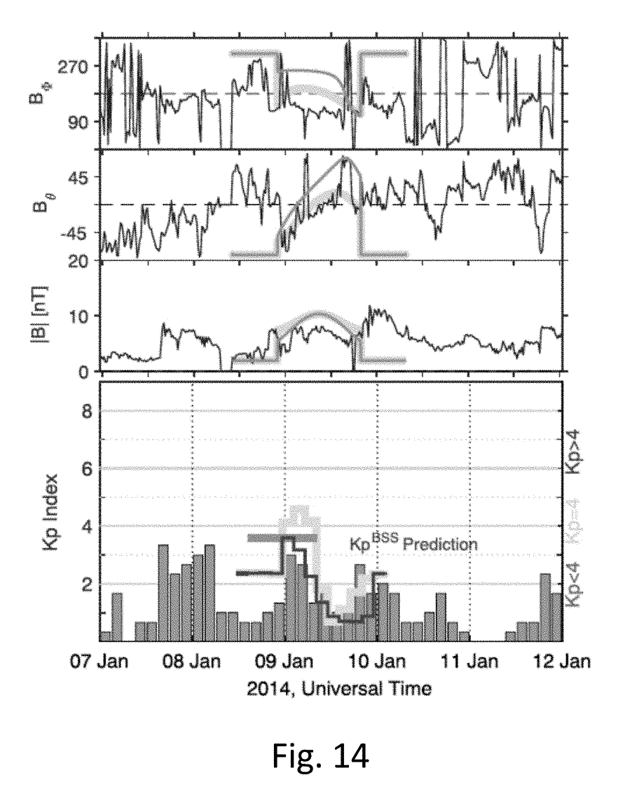

FIG. 14 displays the resulting magnetic vector prediction and Kp^{(BSS)} prediction for this smaller impact parameter. In this scenario, the predicted magnetic vector smoothly rotates over a much larger angle. For this event, the larger field rotation is clearly shown in the B_{θ} component. This faster rotation of the field direction means the field rotates into a northerly direction earlier and for a longer duration, which in turn reduces the maximum Kp^{(BSS)} prediction from 5− to 4−.

### D. Tilt Rotation CME Axis

The predicted magnetic field vectors along a given trajectory can also be changed by varying the tilt of the flux rope axis with respect to the ecliptic (Flux Rope Orientation Module 120). As discussed above, the tilt is determined near the Sun from multi-point coronagraph images preferably using the graduated cylindrical shell (GCS) model, although any other elliptical cone model could be used. While the morphology of a CME can be reasonably well constrained by triangulation using observations from three well-separated spacecraft, uncertainties increase if these spacecraft are in a less than optimal configuration or if observations are not available from every spacecraft.

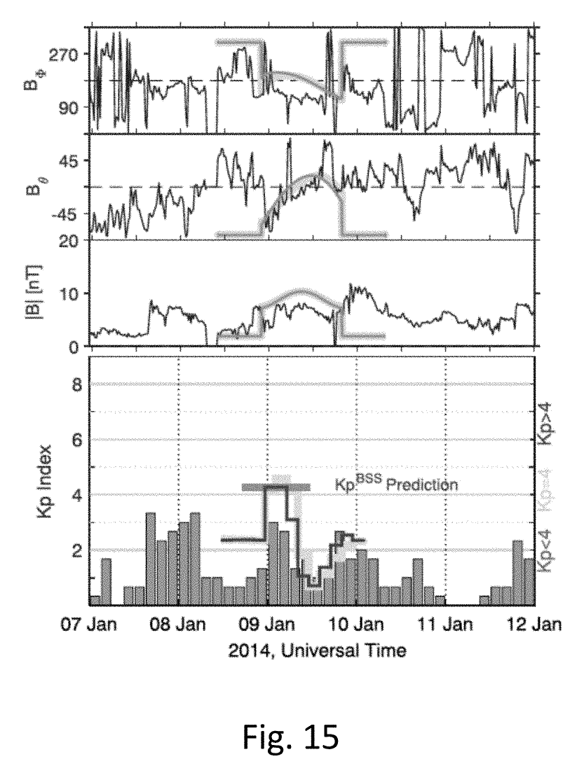

Using FIG. 15, we test the robustness of the time-varying Kp prediction to a change in the tilt angle of the CME axis. The axis is manually increased from 40 degrees to 60 degrees. With this change in CME tilt, the predicted maximum Kp decreases slightly, from 5− to 4+. When the same tilt angle change was combined with the lower impact parameter discussed above, the predicted maximum Kp decreased further, to 3+ (not shown). For this case, the Earth's trajectory changes from being slightly East of the CME's central nose to slightly West. This has an important consequence on the predicted heliocentric radial component of the CME axis direction, which changes sign.

### E. Variations of the Magnetic Field Strength

For the purposes of providing an early lead-time estimate of the magnetic vectors arriving at L1, we estimate the field strength along the central axis of the CME (|B| Field Module 130) by incorporating results from ENLIL simulation runs provided by CCMC/SWRC. CCMC/SWRC make predictions and forecasts based on the maximum field strength and CME velocity at L1 from the WSA-ENLIL+Cone model. These maximum values usually pertain to the sheath plasma pile-up region ahead of a CME. Essentially, this method correlates the estimated CME field strength to the assumed CME momentum (from observations and ENLIL) and the different background solar wind conditions. Several other techniques to estimate the magnetic field strength in CMEs have been suggested, but do not provide a consistently reliable estimate for all observable CME events.

A statistical approach is used to estimate the uncertainty in the magnetic field strength. In Lepping, et. al (2006), (A summary of Wind magnetic clouds for years 1995-2003: Model-fitted parameters, associated errors and classifications, Ann. Geophys., 24, 215-245, doi:10.5194/angeo-24-215-2006) 82 CME events were investigated using in situ observations from the WIND spacecraft. The authors fitted a constant alpha flux rope model to observed CME magnetic fields and determined the standard deviation of the magnetic field strength at the central flux rope axis to be σ=6.9nT. For this study, we chose to vary the field strength as |B|_{-1σ}^{+2σ}. The reason for choosing a larger positive uncertainty is that predictions of maximum geo-effectiveness are of particular interest for storm forecasting and, with this choice, the uncertainty is biased towards larger fields that will lead to higher geomagnetic activity if the field is favorably orientated.

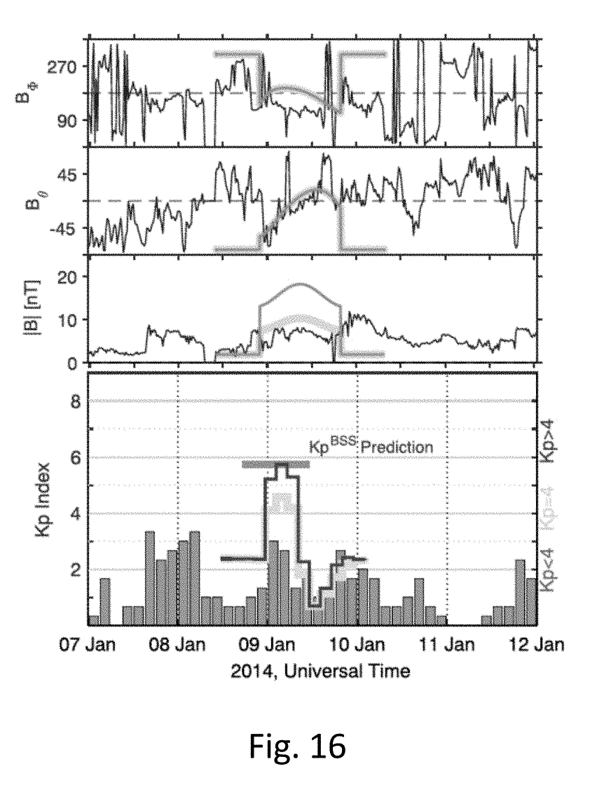

FIG. 16 displays the resulting magnetic vector prediction and Kp^{(BSS)} prediction for a manual increase in the maximum field strength along the central axis by 2σ(|B|=31.8 nT). In this scenario, the predicted direction of the magnetic vector in the B_{θ} and B_{ϕ} panels remains unchanged. However, a dramatic and uniform increase in the field strength extending over the duration of the event has a relatively simple effect on Kp: Since dΦ/dt increases, Kp^{(BSS)} also increases. The double peak in the predicted Kp^{(BSS)} remains but with a faster rise and reaching a larger maximum Kp (increasing from 5− to 6).

### E. Variations to CME Velocity

In order to simulate a real-time forecasting scenario, we test the BSS magnetic field technique in a real-time forecasting setting. We use the maximum velocity along the Earth trajectory (used by the Geomagnetic Response Module 180) from a real time WSA-ENLIL+Cone model run by CCMC/SWRC.

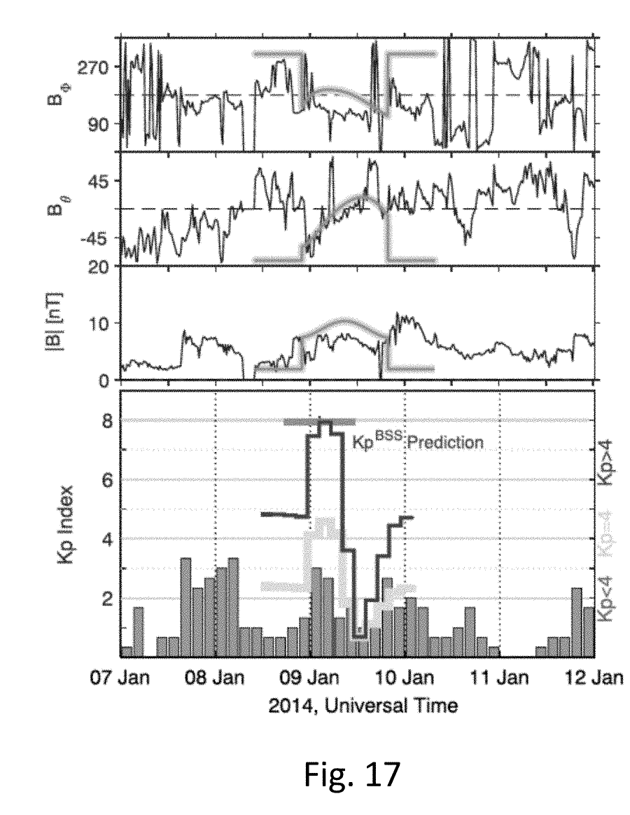

FIG. 17 displays the Kp^{(BSS)} generated by the CCMC/SWRC 840 km/s velocity estimate. This is an increase of 470 km/s from the observed speed at WIND (370 km/s), and above the 20 variation in the predicted velocity. The effect of this velocity is to increase the rate at which the Kp values rise and to reach a higher maximum value (increasing from 5− to 8). For this case study, the change to the maximum estimated Kp_{(BSS)} is very large. Usually the uncertainty of the CME velocity (relative to the measured speed) is smaller than the relative uncertainty of the field magnitude.

A simple view of equation 1 (discussed above) indicates changes to the CME velocity (via the effect of v^{4/3}) would have a greater impact on the Kp^{(BSS)} than the magnetic field strength. However, the dynamic range of expected maximum magnetic field is larger than the velocity, and the uncertainty in the velocity decreases as the arrival time predictions become more accurate. Both arrival-time and CME speed at the Sun are separate estimates that are well investigated with many attempts to improve both of these prediction parameters in the current literature. We wish to understand and isolate the effects of the predicted magnetic vectors without prejudice from these arrival-time estimates.

### III. Skill Scores

To test the capability of the present BSS technique to predict Kp, a variety of skill scores were applied to the eight CMEs discussed above. As with all skill scoring systems, the definition of an “event” must be carefully defined in such a way that the same definition can also be used in future tests of a larger number of events or other forecasting. The definitions must also consider time-discretization of an event as well as relevant thresholds for a “Hit.” An “event” is defined herein for this purpose as a 3-hour period corresponding to a single Kp value, and the interval investigated as the period of “active solar wind” during the passage of a CME and its associated structures (e.g., shock and sheath).

### A. Current Static Skills

The Government Performance and Results Act metrics for NOAA/SWPC are based on the performance of geomagnetic storm forecasts, which monitor the Kp index. NOAA/SWPC geomagnetic Storm Forecast Accuracy is measured as the percentage of times that the 24 hour geomagnetic storm forecast is correct for the 60 most recent geomagnetic storms. The 24 hour geomagnetic storm forecast is considered accurate if a Kp=5 (G1 storm) or greater storm event was predicted. This measure is based on the next-day forecast of maximum Kp, and is verified against the NOAA Kp estimated from ground-based magnetometer observations.

By monitoring the forecast skill in a 24 hour “event” block, the duration of an entire solar storm passing over Earth, or “active solar wind” period, is individually assessed as a single event within a contingency table (or skill score matrix). This time-static approach to measuring the skill score has two major implications: (1) a comparison of the BSS model forecast to NOAA forecasts is less pertinent, as one focuses on how the Kp index varies during a solar storm and, the other on the overall maximum Kp impact of a solar storm; and (2) the significantly lower time-resolution of the forecasting skill used by NOAA drastically reduces the total number of events to below where reliable statistical analysis can be performed. Indeed, NOAA/SWPC assess over the 60 most recent geomagnetic storms to maintain statistical significance for their important probability of detection (POD) metric.

We investigated the “Hit” criteria based on the NOAA/SWPC methodology. An event is considered to be the entire duration of a CME interval, and a “Hit” is defined when both predicted and observed have Kp≥5. As the lead-time forecast for the BSS model is greater than 24 hours, the first available NOAA/SWPC 3-day forecast that includes an influence of the CME was investigated.

As NOAA/SWPC transitioned to forecasting the G scale (Kp Index) in 2012, we investigated the skill for the six CME events between 2012-2014. The NOAA/SWPC forecasting accuracy, the probability of detection, were POD=0.8 for these CMEs. The official NOAA/SWPC Geomagnetic Storm Forecast Accuracy between 2012 and 2014 were POD=47% and 40%, respectively, while also achieving their target accuracy of 53% in 2015. Accordingly, six CME events (c-h) can be considered as between typical and relatively better forecasted than the annual averages, although using a smaller sample of the NOAA forecasts.

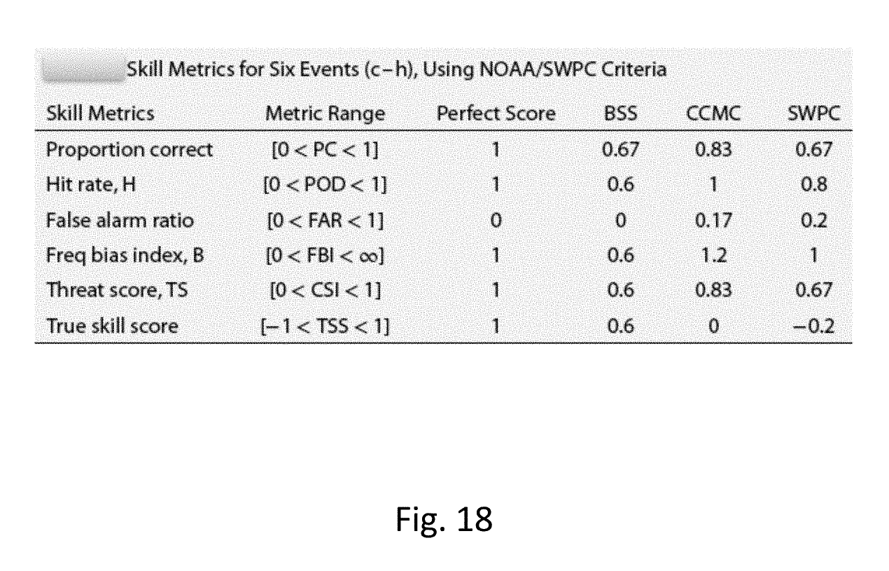

The table shown in FIG. 18 displays further skill metrics using the same “Hit” criteria for forecasts made by NOAA/SWPC, CCMC/SWRC and the equivalent BSS model of the present invention. Due to the limitation of statistics in our sample size, care was required prior to drawing strong conclusions. For this reason, the majority of skill tests shown in FIG. 18 show comparable results between the different forecast techniques. There appears significant improvement in the True skill score metric.

### B. Model Static Skills

A more appropriate metric skill score designed to investigate how the Kp forecast varies during the passage of a CME (i.e., within the active solar wind period) will now be discussed. This new skill criterion also addresses the limitation of statistics in the prior NOAA/SWPC methodology.

The CCMC/SWRC Kp prediction is considered as the baseline to which our predicted Kp^{(BSS)} is compared. On a practical sense, the long lead-time Kp predictions by CCMC/SWRC are generally a static maximum Kp value that will be reached at some point within the uncertainty of the arrival time. This methodology by CCMC/SWRC provides a comparable forecast to NOAA/SWPC alerts.

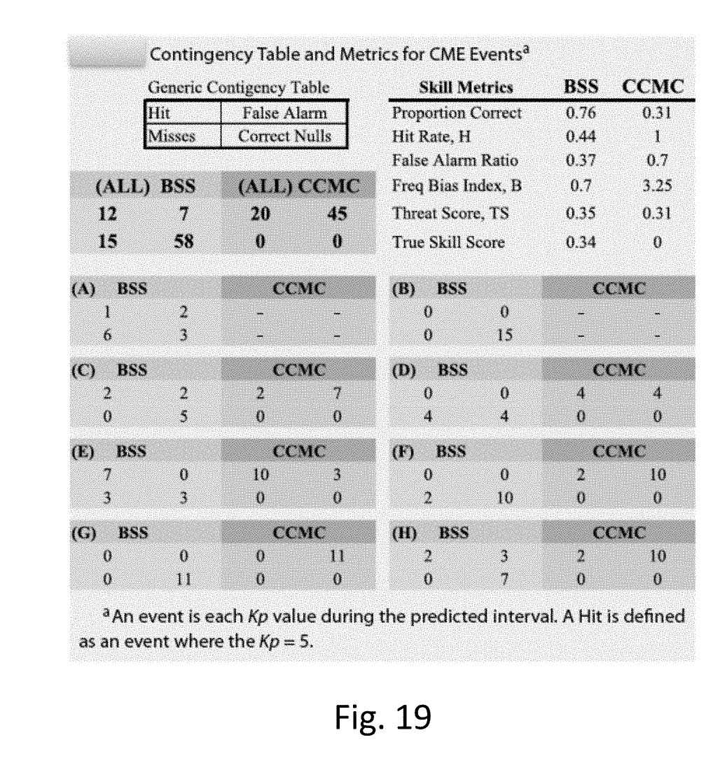

FIG. 19 is a table that displays the contingency table for each CME when a single event is a 3-hour Kp interval and a “Hit” is defined when both observed and predicted (BSS) have Kp≥5 (i.e., Kp^{(o)}≥Kp^{(BSS)}). A “Correct Null” is defined when neither the observed nor predicted Kp is found to be ≥5 (i.e., meets or exceeds the NOAA G1 storm level).

Although Kp is defined for 3 hour periods, predicted variations in the IMF are made on shorter time scales, and can influence the level of geomagnetic activity (e.g., geomagnetically induced currents). Hence, averaging the IMF over intervals that match those of Kp may suppress features that are important drivers of geomagnetic activity. Nevertheless, we choose to average the Kp estimate from the field vectors predicted by the BSS model over the same 3-hour intervals as the Kp values, as this currently represents the service provided by NOAA/SWPC. NOAA/SWPC storm level and provides a consistent threshold for future development, without which ambiguity may persist in defining a successful forecast threshold magnitude for magnetic field components (e.g. B_{y} or B_{z}).

The comparison between observed and predicted Kp is performed after time shifting the Kp^{(BSS)} to a region of maximum correlation. The start time of the predicted Kp^{(BSS)} is placed at the estimated observed storm “sudden commencement” and allowed to shift to maximize the correlation with the observed, with a maximum time shift restricted to 9 hours (3 Kp events). By enabling this time adjustment, each forecast method provides their best possible skill metrics, without introducing skill score uncertainty that is driven by the uncertainty of arrival time predictions.

For the January 2014 event, the CME arrival time is poorly defined since this made a glancing encounter with the Earth and there are no clear signatures of CME arrival. In fact, the delayed arrival falls outside the time shifting window around the official initially forecasted arrival. For completeness, the skill scores for the later arrival time of this CME (i.e., a different assumed “active solar wind” period) were estimated for all the different “Hit” criteria discussed below. In every case, no changes to the skill metrics were observed.

### C. Stricter Criteria

Defining a “Hit” criteria under a stricter regime that not only predicts the occurrence of a geomagnetic storm, but also correctly predicts the storm size under the NOAA G-scale, will now be discussed. As the predicted size of an observed storm is relevant to stakeholders, testing this “Hit” criteria is insightful for future forecasting development.

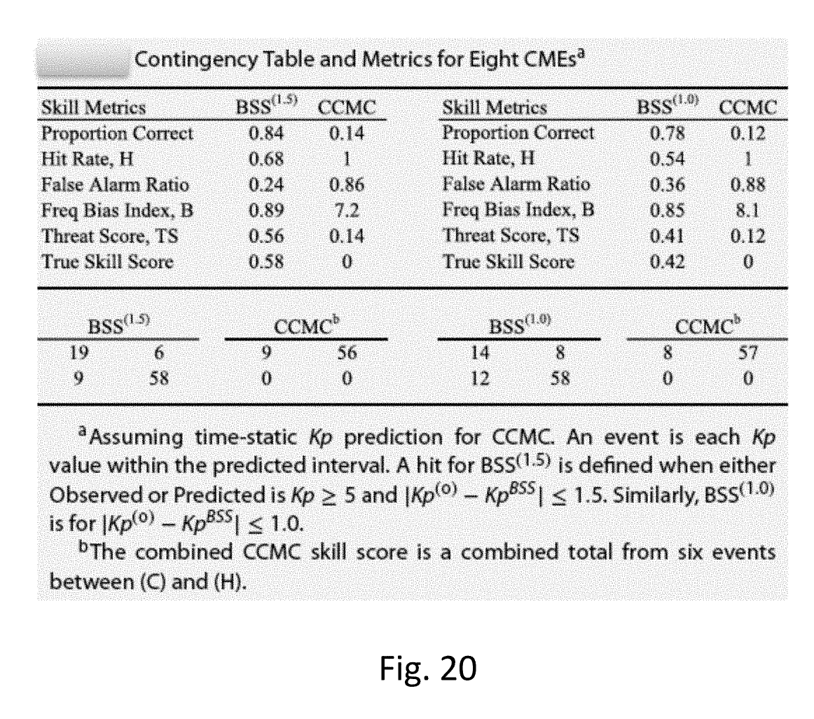

A “Hit” is defined both when: (1) either the observed or predicted goes above the threshold (defined as Kp≥5); and (2) when the observed and predicted Kp values are of similar values to each other. In this case, the requirement is such that |Kp^{(o)}−Kp^{(BSS)}|≤1.5. A more stringent criterion of Kp^{(o)}−Kp^{(BSS)}|≤1.0 was also investigated. The Kp difference of 1.5 is tested as there is evidence that a limitation in accuracy is present in the underlying empirical Kp formulation. However, there will naturally be a long-term desire to correctly forecast the precise G-scale storm classification, which drives the most stringent Hit. The contingency table and skill metrics for these results using the BSS model and CCMC/SWRC predictions are shown in the table of FIG. 20.

By inspecting the metrics of both the CCMC/SWRC and BSS models we note a number of interesting insights. Under a time-static forecast regime, CCMC/SWRC has a perfect hit rate. With closer inspection, the results are extremely biased and significantly over-forecast, which also leads to a large false alarm ratio. As a result, the CCMC/SWRC displays no skill under a Hanssen-Kuiper discriminant (True skill score test). Alternatively, although the BSS model of the present invention shows a lower hit rate, the results are significantly closer to being unbiased, with the True skill score varying between 0.4 and 0.6 for the two stringent criteria described above.

### D. Time-Varying Skills

Correcting the time-static forecast model that led to zero skill level under the TSS test will now be discussed. The single value for an entire geomagnetic storm is improved by incorporating the predicted time-varying Kp values for both NOAA/SWPC and CCMC/SWRC forecasts.

Both NOAA/SWPC and CCMC/SWRC have a methodology that provides time-varying Kp values more than 24-hours in advance. NOAA/SWRC based their technique with more emphasis on a heuristic approach of the on-duty forecasters skill, while CCMC/SWRC drive their estimates using the ENLIL simulation and equations. To test the Kp formulae, a separate baseline approach can be directly taken from the real-time in-situ data (T0) and from solar wind conditions 27 days earlier (T27). Therefore, it is possible to compare these four time-varying predictions with the BSS method of the present invention.

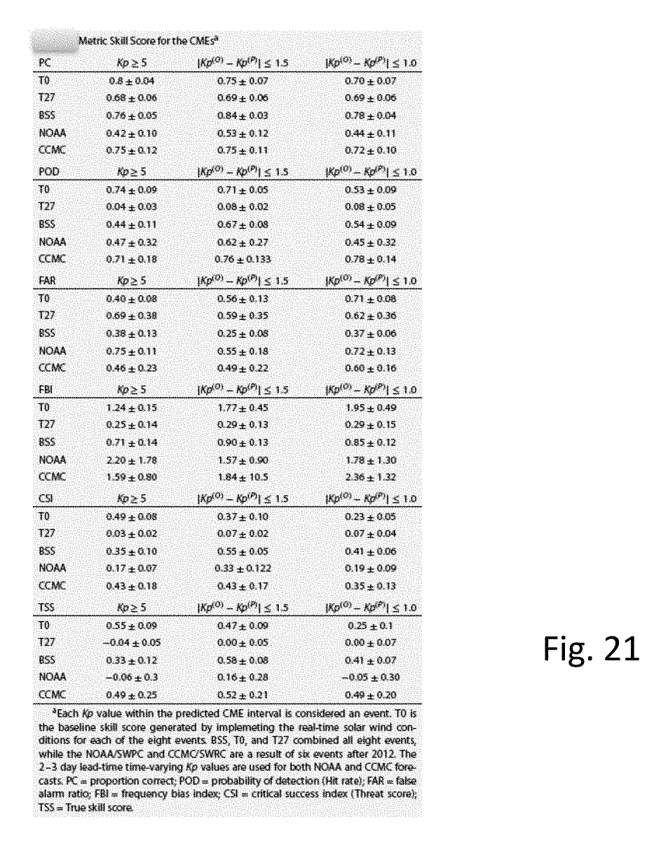

The table shown in FIG. 21 displays the overall metric skills for T0, T27, BSS, NOAA/SWPC and CCMC/SWRC. The compilation of the scores are for the three “Hit” thresholds used earlier. For both NOAA/SWPC and CCMC/SWRC, the first possible release of the time-varying Kp values with CME information were used to compare against the observed. For both NOAA/SWPC and CCMC/SWRC, the six CME events between 2012 and 2014 (events c-h) were used in estimating the skill scores, because data prior to 2012 were unavailable. The uncertainty and averages were estimated using the jackknife method from all 28 combinations of choosing six CMEs from the total of eight CMEs available for investigation. For NOAA/SWPC and CCMC/SWRC, the uncertainty was determined from 20 combinations of choosing three CMEs from the total of six CME events.

The skill score for the BSS display a general improvement on the T0, T27, NOAA/SWPC and CCMC/SWRC methodologies when one focuses on the more stringent requirements that the predicted and observed magnitudes must be of comparable size. The skill of the T0 baseline also significantly and smoothly decreases as the “Hit” criteria becomes more stringent, which is approximately consistent with recent results by Mays, M. L., et al. (2015), Ensemble modeling of CMEs using the WSA-ENLIL+cone model, Sol. Phys., 290, 1775-1814, doi:10.1007/s11207-015-0692-1. The Kp empirical formulation is accurate to about Kp=1.5.

### IV. Discussion of BSS Model and Kp Model Skills

### A. BSS Model

The analysis of varying the predicted magnetic field within a CME for all eight events showed that the majority of the effects on Kp^{(BSS)} were caused by the changes to the CME velocity and field strength. In the case study January 2014 event, where the velocity was significantly overestimated during the real-time forecasting process, the uncertainty in velocity had a larger effect on the Kp^{(BSS)} than the field strength.

For CME event “d”, in June 2012, the predictive limitations of the very strong field strength reduced the accuracy of the Kp predictions. Prior evidence has suggested the reason be due to southerly IMF strength being the most dominant solar wind parameter for driving geomagnetic activity at Earth. The strong correlation of solar wind speed to geomagnetic activity is evident during CME conditions, but is only considered the most dominant parameter during high speed streams.

Accordingly, the metrics were focused towards estimating the Kp^{(BSS)} variability with the magnetic field strength. This simplified method for uncertainty analytics is chosen as a practical solution to quickly implement within forecasting procedures. With the hope of more sophisticated techniques being designed as a larger number of events are investigated and a suitable methodology for direct comparison between the predicted and observed magnetic vectors can be developed.

As a simple test of the magnetic B_{z} component, a mean square error (MSE) was calculated between the real time in-situ data (T0) and a baseline predictor created by using the solar wind conditions 27 days earlier (T-27). A similar MSE was estimated with the BSS prediction model values and both MSE's were compared while using 10 minute resolution. Using Laplace's law of succession for small sample sizes, the BSS scheme is likely to provide a more accurate prediction for 60% of CMEs when estimating the magnetic field B, component and clock angle. However, these results would strongly benefit from a larger sample size.

FIGS. 11-15 illustrate the effects of changing the hypothetical Earth-trajectory through the magnetic flux rope model. For cases when reliable triangulation of the CME direction is not possible and reliance of CME tilt is determined by solar disc imagery, then large differences in the hypothetical trajectory are possible. This does have a significant impact on the estimated magnetic vectors at L1.

Assuming multi-spacecraft analysis of a CME is possible, a smaller range of uncertainty in the hypothetical trajectory is possible. Small increases in the impact parameter Y₀, perpendicular to the FR axis) causes the angular change of the vectors during passage of the CME to decrease. For an event where the spacecraft trajectory is close to the central axis of the flux rope, the field vectors are relatively unaffected by small uncertainties in the trajectory, whereas larger changes occur for trajectories well outside the central axis. However, the largest geomagnetic impacts result from near-central axis encounters for which the field vectors are evidently less influenced by the spacecraft trajectory.

By using statistical analysis Riley et al. (Riley, P., and I. G. Richardson (2013), Using statistical multivariable models to understand the relationship between interplanetary coronal mass ejecta and magnetic flux ropes, Sol. Phys., 284, 217-233, doi:10.1007/s11207-012-0006-9) suggest that a distinct magnetic flux rope object may be contained within an overall propagating CME structure and that the plasma-β is a good predictor variable. Savani et al. (Savani et al. (2013), A plasma β transition within a propagating flux rope, Astrophys. J., 779, 142, doi:10.1088/0004-637X/779/2/142) used simulations to confirm that such a scenario of a distinct coherent core obstacle can occur within the CME structure and that a transition in plasma-β can be observed. Therefore, the BSS model contains a region outside the central axis region but within the “volume of influence” which is considered to be also composed of the sheath solar wind that has been disturbed by interactions with the CME and contains magnetic field lines that are draped around the CME, or CME plasma which is outside the flux rope structure.

The constant alpha flux rope model is often used as a benchmark structure from which more sophisticated models are tested. Events that deviate away from this ideal topology are frequently observed. Allowing future models to change the alpha parameter is a simple adjustment that can replicate a non-symmetric time-series of the CME profile. Reducing the alpha parameter may also provide a simple solution to replicate possible flux erosion that has been observed during the CME evolution. Panels E and F in FIG. 8 display two clear examples of where the CME field magnitude is highly non-symmetric.

Panel A in FIGS. 8 and 9 displays a CME-driven storm in April 2010 with maximum observed Kp=8−. However, maximum Kp occurred just prior to the arrival of the magnetic flux rope, and was due to strong southward fields in the sheath upstream of the flux rope. This event highlights the need to forecast the field vectors not only in the flux rope, but also in the sheath.

Panel D in FIGS. 8 and 9 displays a geomagnetic storm during June 2012. This event displays unusually strong magnetic field magnitude that illustrates another problem with the field vector prediction scheme discussed here. This field strength was due to a complex CME-CME interaction. The BSS model is not ideal under such cases, but can indirectly adapt to such a situation if a real-time WSA-ENLIL+cone forecast is provided with an enhanced field strength from interacting CMEs. A CCMC/SWRC forecasting of a CME-CME interaction with the WSA-ENLIL+cone run was not performed, but is likely to increase the magnetic field strength inferred from the model. The uncertainty analysis for the BSS model also accounts for situations of large magnetic field by way of the 20 field variation.

### A. Kp Model Skills

In addition to predicting the Kp index during the passage of CMEs, it is also important to be able to predict Kp during the intervening quiet periods. This suggests that when estimating the skill of a complete forecasting system, it would be useful to measure a set of skills in two-steps: (1) 24-hour probability of detection skill for the periods of quiet and active (or disturbed) solar wind; and (2) a skill estimated using higher time resolution within the active period. Under a proposed 2-step skill scoring system for forecasting, the skill of any CME prediction model can be tested at higher time resolution during important storm epochs where the Kp variability persists within the G1-G5 storm range.

How the 8 CME case study events measured against the official U.S. government metrics used by NOAA/SWPC were investigated. The results and geomagnetic forecast accuracy from our small sample size were similar to the national annual trends measured by NOAA/SWPC, thereby suggesting our event sample is typical.

Skill scores metrics using more complex “Hit” criteria which centered around defining each event to be the same 3-hour duration as a Kp value were also gathered. We defined three “Hit” criteria: (1) when both the observed or predicted goes above the threshold (defined as Kp≥5); (2) when either the observed and predicted Kp values are above 5 and |Kp^{(o)}−Kp^{(BSS)}|≤1.5; and (3) when either the observed and predicted Kp values are above 5 and |Kp^{(o)}×Kp^{(BSS)}|≤1.0.

5 different prediction model techniques were compared. Two were baseline methodologies defined as: (1) T0, the real-time data from L1 spacecraft; and (2) T27, a L1 data time-series taken 27 days prior to the CME arrival. The other three methods were the NOAA/SWPC 3-day forecasts, CCMC/SWRC forecast tests and the BSS prediction model. The full collection of metrics are displayed in FIG. 21.

Unsurprisingly, the baseline T0 model (i.e., real-time prediction) performed with the best skill for a significant number of the metrics tested, while the T27 was more frequently the worst performing and often showing little improvement over having no skill. The T0 model Hit rate was above 70% for all other than the most stringent Hit criteria, where the success dropped to above 50%. The T0 model does show a dramatic increase in the false alarm ratio (FAR) as the Hit criteria became more stringent, and this can be partially explained by the significant increase in the bias to over-forecast (FBI). The decrease in skill can be partly interpreted as a limitation in accuracy of the underlying empirical relationship between the magnetic vectors to the Kp Index.

The Hit rate (POD) for the 3-day lead-time NOAA/SWPC forecast, where we investigate the individual Kp values during a geomagnetic storm, shows similar results to their official metrics. Moreover, these results appear robust to the more stricter Hit criteria. However, the large false alarm ratio and false alarm rate with very bias over-forecasting has led to an extremely low True skill score (TSS) value.

The CCMC/SWRC demonstrated a Hit rate as consistently good (above 70%) as the real-time T0 forecast model. However, this model also showed the worst over-forecasts bias against all models under all Hit criteria. The threat score (which does not account for correct nulls) also remained strong and out performed the T0 model at the more stringent Hit criteria. The TSS value remained consistently high and again out performed the T0 model. However, the uncertainty in this value remains high and improvement to the statistics is warranted.

The predictions of the BSS model of the present invention have performed consistently amongst the best metrics demonstrated by the other models. Across all Hit crtieria, the BSS predictions have consistently demonstrated the most unbiased results. Under the stricter Hit criteria, the Hit rate of the BSS predictions are comparable to the T0 predictions but not as good as the CCMC/SWRC predictions. The True skill score under the least stringent Hit criteria, were not as good as the T0 or CCMS/SWRC predictions. However, under the stricter Hit criteria, the BSS model predictions beat the T0 predictions and performed equally with CCMC/SWRC while demonstrating a lower uncertainty.

The foregoing embodiments and advantages are merely exemplary, and are not to be construed as limiting the present invention. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims.

What is claimed is:

1. A method of predicting Earth's geomagnetic response to a coronal mass ejection (CME), comprising:
determining an initial magnetic profile of the CME at the Sun base on observations of the source of the CME;
creating a time-varying magnetic profile of the CME;
predicting the magnetic field direction of the CME along Earth's trajectory; and
predicting Earth's geomagnetic response to the CME based on the predicted magnetic field direction at Earth.
